(19) United States
(12) Patent Application Publication
(10) Pub. No.: US 2010/0096831 A1
(43) Pub. Date: Apr. 22, 2010

(54) CENTER OF MASS TECHNOLOGY FOR MOUNTAIN BIKE FRAMES

(76) Inventors: Ted K. Tanouye, Fullerton, CA (US); Alan Kang, Anaheim, CA (US)

Correspondence Address: WOODS PATENT LAW, P.O. BOX 2528, LYONS, CO, 80540, US

(21) Appl. No.: 12/256,152

(22) Filed: Oct. 22, 2008

(51) Int. Cl. B62K 3/02

(52) U.S. Cl. 280/281.1

(57) ABSTRACT

A lightweight mountain bike frame made out of welded aluminum tubing heavily reinforced with open ended gussets, whose design allows peak stress to be more evenly distributed. The design moves the shock mount forward so that the rocker arm fits around the seat tube without mounting a pivot to it, resulting in the weight of the suspension to move to the center of gravity for both bike and rider.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

i. Technical Field

The present invention relates to mountain bike frames.

ii. Background Art

Traditional “diamond” bicycle frames (called the “diamond” frame because when viewed from the side, the top tube, down tube, chain stays, and seat stays enclose a diamond-shaped space) include: a top tube, a relatively short head tube, a seat tube, a down tube, a bottom bracket, a pair of chain stays, a pair of dropouts, and a pair of seat stays. The top tube connects at the front end to the top of the head tube, and extends backward to the top of the seat tube. The down tube connects at the front end to the bottom of the head tube and extends downwardly and rearwardly toward the bottom bracket where the seat tube and the down tube are connected. The pair of chain stays extend rearwardly from the bottom of the seat tube toward the dropouts. The pair of seat stays connect directly or indirectly to the top of the seat tube. The seat stays extend backward from the seat tube to the dropouts. The seat stays generally include two seat stay tubes that converge from the dropouts toward the seat tube. The dropouts support the rear wheel axle. Such frames are used for both road bikes and mountain bikes.

Despite the many developments to bicycles, which have occurred over the past several years, the basic position and/or posture of the rider (and his mass) on top of the bicycle has been changed very little. Typically, the rider stands on the foot pedals, or sits on the seat, and pulls against the handlebars as the pedals are worked. When the bicycle is being ridden uphill, a rider's center of mass is shifted rearward to an extreme, requiring the rider to exaggerate his pedaling causing him to become exhausted quickly. When the bicycle is being ridden downhill, a rider's center of mass is shifted forward to an extreme, again requiring the rider to exaggerate his breaking, which reduces overall bike performance. The present invention has found that by centering the rider's mass on top of the bicycle does not require the rider to exaggerate his movements when riding uphill and downhill resulting in less rider fatigue, greater rider balance, and improved overall bike performance.

### SUMMARY OF THE INVENTION

iii. Disclosure of Invention

It is an object of the present invention to provide a bicycle frame that obviates or mitigates the above-described disadvantages of prior art.

The principle objects and advantages of the present invention are to, through centering the mass of the rider on top of the bicycle, lower the rotational moment of Inertia, resulting in the riders mass becoming more concentrated where pivoting occurs, which result in greater overall control and optimum performance, not to mention making the bicycle easier to turn, being more maneuverable.

### OBJECTS AND ADVANTAGES

Several objects and advantages of the present invention are:
a) With the rider's mass centralized on top of the bike frame, the overall handling of the bike is more natural, so you don't have to consciously shift your weight from the front to the back. With the rider's weight distributed equally, the bike's performance is enhanced and easier to handle.
b) Additionally, with the rider's mass being centralized, the mountain bike will corner more smoothly (also easier to turn) as well as require less effort to pedal when riding uphill.

### DESCRIPTION OF PREFERRED EMBODIMENTS

As will appear in the description following, a person of ordinary skill can by inspection of the drawings ascertain a full description of the invention and of how to make and use it. Preferred embodiments are here described, beginning with a brief description of the drawings.

### BRIEF DESCRIPTION OF DRAWINGS

FIG. 1 is a side view of the mountain bike frame in accordance with the present invention with a description of where the center of mass is located.

### BEST MODE OF CARRYING OUT THE INVENTION

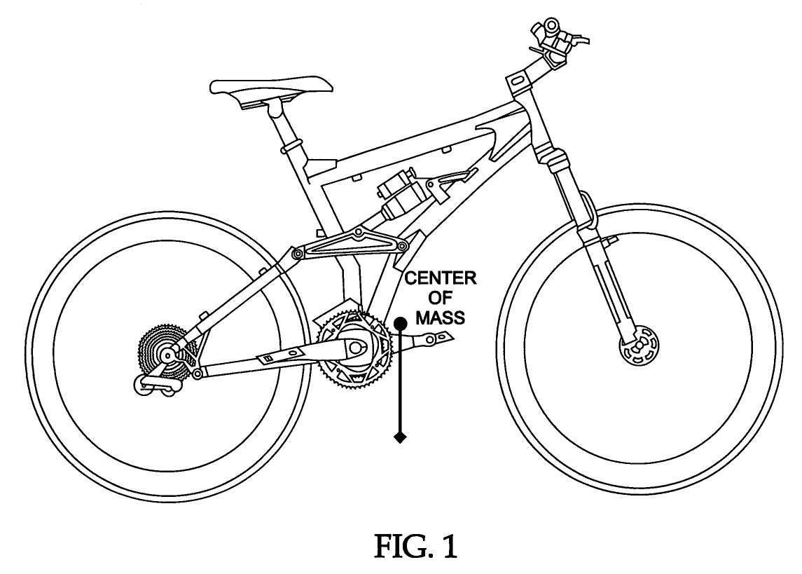

### FIG. 1

### Preferred Embodiment

A preferred embodiment of the CENTER OF MASS TECHNOLOGY FOR MOUNTAIN BIKE FRAMES is illustrated in the accompanying figure (no. 1). The frame is constructed of rigid aluminum tubing welded together and heavily reinforced with open-ended gussets.

What is claimed is:

1) A bicycle frame comprised of a top tube, down tube, chain stays and seat stays, which enclose to form a diamond frame resulting in the center of mass of the bicycle located in front of the crankset and within an imaginary line drawn to represent ⅓ of the horizontal length of the downtube closest to the crankset.

2) The bicycle frame according to claim 1, wherein the center of mass is aligned with an imaginary line drawn through the center of the upper torso of the rider.
